(19) United States
(12) Patent Application Publication
(10) Pub. No.: US 2015/0121891 A1
(43) Pub. Date: May 7, 2015

(54) OXIDATION SYSTEM FOR TREATMENT OF LOW-CONCENTRATION METHANE GAS PROVIDED WITH MULTIPLE OXIDIZERS

(71) Applicant: KAWASAKI JUKOGYO KABUSHIKI KAISHA, Kobe-shi (JP)

(72) Inventors: Shinichi KAJITA, Kobe-shi (JP); Yoshihiro YAMASAKI, Kobe-shi (JP)

(73) Assignee: KAWASAKI JUKOGYO KABUSHIKI KAISHA, Kobe-shi (JP)

(21) Appl. No.: 14/575,345

(22) Filed: Dec. 18, 2014

Related U.S. Application Data
(63) Continuation of application No. PCT/JP2013/066646, filed on Jun. 18, 2013.

(30) Foreign Application Priority Data
Jun. 25, 2012 (JP) 2012-141804

(51) Int. Cl. F02C 6/18; F23R 3/40; F02C 7/08

(52) U.S. Cl. CPC F02C 6/18; F02C 7/08; F23R 3/40; F23R 2900/00002
USPC 60/772; 60/723

(57) ABSTRACT

A low-concentration methane gas oxidation system includes a single heat source device, and an oxidation device which catalytically oxides a low-concentration methane gas by using heat from the single heat source device. The oxidation device includes a plurality of oxidation lines each including each of a plurality of branching low-concentration gas supply passages which branch, in parallel, from a supply passage which supplies the low-concentration methane gas, and each of a plurality of catalyst oxidizers provided on each of the plurality of branching low-concentration gas supply passages.

### CROSS REFERENCE TO THE RELATED APPLICATION

This application is a continuation application, under 35 U.S.C. §111(a), of international application No. PCT/JP2013/066646, filed Jun. 18, 2013, which claims priority to Japanese patent application No. 2012-141804, filed Jun. 25, 2012, the disclosure of which are incorporated by reference in their entirety into this application.

### BACKGROUND OF THE INVENTION

1. Field of the Invention

The present invention relates to a system which oxidizes a low-concentration methane gas such as VAM (Ventilation Air Methane) generated from a coal mine.

2. Description of Related Art

In order to reduce greenhouse effect gases, it is necessary to oxidize a low-concentration methane gas such as VAM discharged from a coal mine to the atmosphere. As such an oxidation apparatus, hitherto, a system is known in which VAM is oxidized by catalytic combustion using waste heat from an external heat source device (e.g., Patent Document 1). In the example of Patent Document 1, a low-concentration methane gas is heated to a catalytic reaction temperature by using waste heat from a lean fuel gas turbine engine. Thereafter, the low-concentration methane gas is caused to flow to a catalyst layer, and is burned there.

### RELATED ART DOCUMENT

### Patent Document

[Patent Document 1] Japanese Patent No. 4538077

### SUMMARY OF THE INVENTION

In the oxidation system disclosed in Patent Document 1, only one catalytic oxidation apparatus can be combined with one gas turbine engine. Therefore, if the discharge amount of VAM to be treated is enormous, it is necessary to provide a plurality of oxidation systems each including a gas turbine engine and a catalytic oxidation apparatus. However, it is sometimes difficult to provide a plurality of such systems in terms of installation space and cost. As a result, sufficient VAM treatment performance cannot be achieved.

In order to solve the above problem, an object of the present invention is to provide a low-concentration methane gas oxidation system in which a plurality of catalyst oxidizers are combined with a single heat source device, thereby to treat an enormous amount of low-concentration methane gas at a low cost while suppressing an increase in a space where the system is installed.

In order to achieve the above-described object, a low-concentration methane gas oxidation system according to the present invention includes: a single heat source device; and an oxidation device to catalytically oxidize a low-concentration methane gas by using heat from the single heat source device, the oxidation device including a plurality of oxidation lines, and each oxidation line including: each of a plurality of branching low-concentration gas supply passages which branch, in parallel, from a supply passage to supply the low-concentration methane gas; and each of catalyst oxidizers provided on each of the plurality of branching low-concentration gas supply passages. An example of the heat source device may be a lean fuel intake gas turbine using, as a fuel, a combustible component contained in a low-concentration methane gas.

According to the above configuration, since the plurality of catalyst oxidizers are combined with the single heat source device, it is possible to treat an enormous amount of low-concentration methane gas at a low cost while suppressing an increase in the space where the system is installed.

In one embodiment of the present invention, the oxidation lines may include a first oxidation line including: a first catalyst oxidizer provided on a first branching low-concentration gas supply passage branching from the most upstream side of the supply passage; a first preheater to preheat the low-concentration methane gas before the low-concentration methane gas flows into the first catalyst oxidizer, by using the heat from the heat source device; and a first heat exchanger to preheat the low-concentration methane gas before the low-concentration methane gas flows into the first catalyst oxidizer, by using, as a heating medium, a treated gas discharged from the first catalyst oxidizer, and at least one additional oxidation line branching from the downstream side of the first oxidation line in the supply passage, and including: an additional catalyst oxidizer to catalytically oxidize the low-concentration methane gas; an additional preheater to preheat the low-concentration methane gas before the low-concentration methane gas flows into the additional catalyst oxidizer, by using the heat from the heat source device or heat of a gas oxidized in another oxidation line provided at an upstream side thereof; and an additional heat exchanger to preheat the low-concentration methane gas before the low-concentration methane gas flows into the additional catalyst oxidizer, by using, as a heating medium, a gas oxidized in the additional oxidation line. According to this configuration, since the heat from the heat source device is directly or indirectly used for catalytic oxidation in the plurality of oxidation lines, the efficiency of the entire system can be enhanced.

In one embodiment of the present invention, the first oxidation line may include, as the preheater, a mixer to mix the low-concentration methane gas with a heat source gas supplied from the heat source device. The at least one additional oxidation line may include, as the preheater, a mixer to mix the low-concentration methane gas with a high-temperature gas supplied from the heat source device. According to this configuration, since the heat source gas from the heat source is mixed with the low-concentration methane gas, the low-concentration methane gas can be efficiently preheated, and moreover, the heat source gas can be introduced into the catalyst oxidizer and the heat exchanger at the downstream side of the catalyst oxidizer.

When the mixer is provided as the preheater as described above, each of the first oxidation line and the at least one additional oxidation line is preferably provided with a low-concentration gas flow rate regulating valve to regulate an inflow rate of the low-concentration methane gas, and a heating medium flow rate regulating valve to regulate an inflow rate of the heat source gas. According to this configuration, by controlling these two regulating valves, it is easy to successively start up the first oxidation line and the additional oxidation line by using the heat source gas from the heat source device.

In one embodiment of the present invention, the first oxidation line may include, as the first preheater, a heat source gas heat exchanger to preheat the low-concentration methane gas by using, as a heating medium, the heat source gas supplied from the heat source device. The at least one additional oxidation line may include, as the additional preheater, an additional oxidation gas heat exchanger which uses, as a heating medium, the gas oxidized in the another oxidation line at the upstream side thereof. According to this configuration, it is possible to enhance the efficiency of the system by preheating the low-concentration methane gas in the two stages while simplifying the configuration of the heat source gas supply passage.

A method of operating the low-concentration methane gas oxidation system according to the embodiment including the low-concentration gas flow rate regulating valve and the heating medium flow rate regulating valve as described above, including: when the system is started up, closing the low-concentration gas flow rate regulating valve and the heating medium flow rate regulating valve of the additional oxidation line, and controlling apertures of the low-concentration gas flow rate regulating valve and the heating medium flow rate regulating valve of the first oxidation line such that the inflow rate of the low-concentration methane gas is smaller than the inflow rate of the heat source gas; in the first oxidation line, after oxidation in the catalyst oxidizer is started, reducing the aperture of the heating medium flow rate regulating valve and increasing the aperture of the low-concentration gas flow rate regulating valve in accordance with an increase in a catalyst combustion temperature in the catalyst oxidizer; after catalytic oxidation reaction reaches a steady state in the catalyst oxidizer in the first oxidation line, closing the heating medium flow rate regulating valve and the low-concentration gas flow rate regulating valve of the first oxidation line; in the additional oxidation line provided at the downstream side of the first oxidation line, increasing the aperture of the heating medium flow rate regulating valve of the additional oxidation line in association with a reduction in the aperture of the heating medium flow rate regulating valve of the first oxidation line, thereby to cause a flow rate of the heat source gas corresponding to a decrease in the inflow rate of the heat source gas into the first oxidation line to flow into the additional oxidation line, and opening the low-concentration gas flow rate regulating valve of the additional oxidation line, thereby to cause a smaller flow rate of the low-concentration methane gas than the inflow rate of the heat source gas to flow into the additional oxidation line; and in a case where a plurality of the additional oxidation lines are provided, successively repeating, between an upstream-side additional oxidation line and a downstream-side additional oxidation line, the above-described procedures in the first oxidation line and the additional oxidation line at the downstream side of the first oxidation line.

According to the above configuration, by controlling the two regulating valves, it is easy to successively start up the first oxidation line and the additional oxidation line by using the heat source gas from the heat source device.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a block diagram showing a schematic configuration of a low-concentration methane gas oxidation system according to a first embodiment of the present invention;

FIG. 2 is a block diagram showing a schematic configuration of a low-concentration methane gas oxidation system according to a modification of the first embodiment of the present invention; and

FIG. 3 is a block diagram showing a schematic configuration of a low-concentration methane gas oxidation system according to a second embodiment of the present invention.

### DESCRIPTION OF EMBODIMENTS

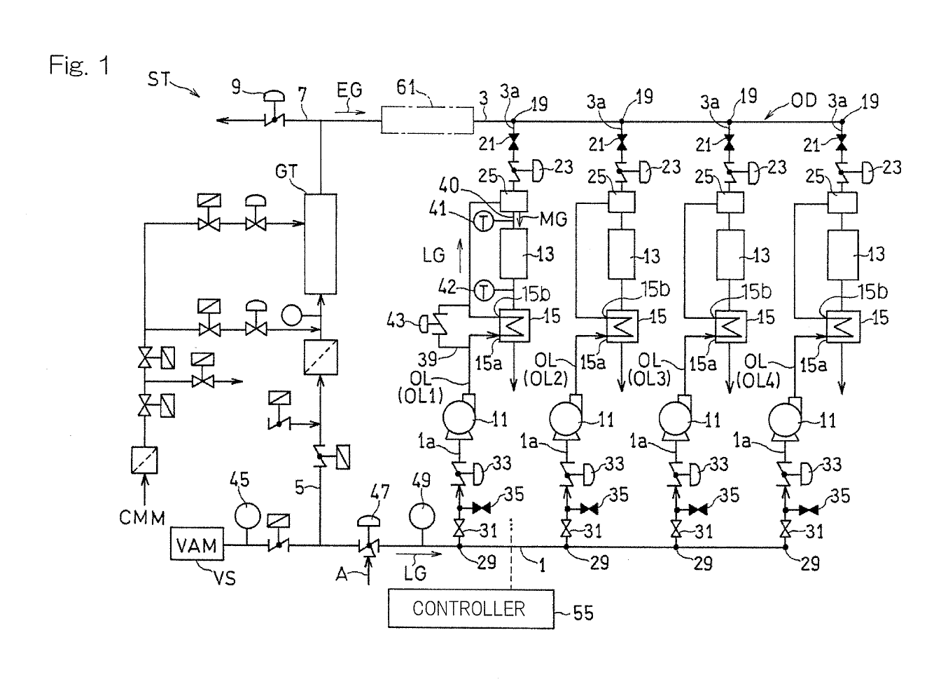

Hereinafter, embodiments of the present invention will be described with reference to the drawings. FIG. 1 is a schematic configuration diagram showing a low-concentration methane gas oxidation system (hereinafter, referred to simply as “oxidation system”) ST according to a first embodiment of the present invention. The oxidation system ST oxidizes a low-concentration methane gas such as VAM discharged from a coal mine, at a low-concentration methane gas oxidation device OD by using waste heat from a gas turbine engine GT which is a single heat source device.

In the present embodiment, a lean fuel intake gas turbine is used as the gas turbine GT. The lean fuel intake gas turbine uses, as a fuel, a combustible component contained in a low-concentration methane gas LG which is an oxidation treatment target of the oxidation system ST. As an example of the low-concentration methane gas LG used in the gas turbine engine GT, VAM generated from a coal mine is used. To the methane gas oxidation device OD and the gas turbine GT, VAM as the low-concentration methane gas LG is supplied from a shared VAM supply source VS. The gas turbine engine GT of the present embodiment uses, as a fuel, in addition to VAM, CMM (Coal Mine Methane) which is a low-concentration methane gas having a methane concentration higher than that of VAM.

The low-concentration methane gas oxidation device OD includes: a low-concentration gas supply passage 1 which supplies the low-concentration methane gas LG as an oxidation treatment target; a heating medium supply passage 3 which supplies a gas turbine exhaust gas EG serving as a heating medium (heat source gas) for the low-concentration methane gas LG; and a plurality of (four in the example of FIG. 1) oxidation lines OL connected between the low-concentration gas supply passage 1 and the heating medium supply passage 3 in parallel to these supply passages 1 and 3. The low-concentration gas supply passage 1 is provided so as to branch from a fuel supply passage 5 which supplies the low-concentration methane gas LG from the VAM supply source VS to the gas turbine engine GT. The heating medium supply passage 3 is provided so as to branch from an exhaust gas discharge passage 7 which discharges the gas turbine exhaust gas EG from the gas turbine engine GT to the outside. In the exhaust gas discharge passage 7, an exhaust gas flow rate regulating valve 9 which regulates the discharge flow rate of the exhaust gas EG is provided at the downstream side of a branch point to the heating medium supply passage 3.

Each oxidation line OL includes a blower 11, a catalyst oxidizer 13, and an oxidation gas heat exchanger 15. To the catalyst oxidizer 13, the low-concentration methane gas LG is supplied via a branching low-concentration gas supply passage 1a which branches, in parallel, from the low-concentration gas supply passage 1. Although in the present embodiment, the oxidation lines OL have the same configuration, in the following description, according to need, the oxidation line provided at a position closest to the gas turbine engine GT as the heat source device (in other words, provided at the most upstream side with respect to the heating medium supply passage 3) may be referred to as a first oxidation line OL1, and the additional oxidation lines provided at the downstream side of the first oxidation line OL1 may be referred to as, in order from the upstream side, a second oxidation line OL2 to a fourth oxidation line OL4.

The configuration of each oxidation line OL will be described in more detail. In the oxidation line OL, a branching heating medium supply passage 3a is provided at the downstream side of a branch point 19 from the heating medium supply passage 3, and a heating medium on-off valve 21 and a heating medium flow rate regulating valve 23 are provided in order in the branching heating medium supply passage 3a. A mixer 25 and the catalyst oxidizer 13 are provided in order at the downstream side of the heating medium flow rate regulating valve 23, and the oxidation gas heat exchanger 15 is provided at the downstream side of the catalyst oxidizer 13.

Meanwhile, in the oxidation line OL, a low-concentration gas on-off valve 31 and a low-concentration gas flow rate regulating valve 33 are provided in order at the downstream side of a branch point 29 from the low-concentration gas supply passage 1. The blower 11 which supplies the low-concentration methane gas LG to the oxidation gas heat exchanger 15 is provided at the downstream side of the low-concentration gas flow rate regulating valve 33, and a downstream side of the blower 11 is connected to a medium-to-be-heated inlet 15a of the oxidation gas heat exchanger 15. A heated medium outlet 15b of the oxidation gas heat exchanger 15 is connected to the mixer 25. In addition, a bypass air valve 35 for cooling and replacing the oxidation line OL with air at the time of maintenance is connected between the low-concentration gas on-off valve 31 and the low-concentration gas flow rate regulating valve 33.

An inlet side passage and an outlet side passage for the low-concentration methane gas LG as a medium to be heated in the oxidation gas heat exchanger 15 are connected to each other by a heat exchanger bypass 39 which bypasses the low-concentration methane gas LG from the oxidation gas heat exchanger 15. In a heating medium inlet side passage 40 provided at the downstream side of the mixer 25, a first temperature measurement unit 41 which measures the temperature of the heating medium flowing into the catalyst oxidizer 13, and a second temperature measurement unit 42 which measures the temperature of the heating medium flowing out of the catalyst oxidizer 13 are provided. In the middle of the heat exchanger bypass 39, a bypass flow rate control valve 43 which controls the flow rate of the bypassed low-concentration methane gas LG is provided. When the temperature at the second temperature measurement unit 42 exceeds a predetermined value, the aperture of the bypass flow rate control valve 43 is controlled to increase the flow rate of the low-concentration methane gas LG flowing through the heat exchanger bypass 39. Thereby, the temperature of the heating medium is decreased at the inlet of the catalyst oxidizer 13, and thus the catalyst in the catalyst oxidizer 13 is prevented from being excessively heated. Although not shown in FIG. 1, the heat exchanger bypass 39, the temperature measurement units 41 and 42, and the bypass flow rate control valve 43 are also provided in each of the second to fourth oxidation lines OL2 to OL4.

The low-concentration methane gas LG supplied from the VAM supply source VS through the low-concentration gas supply passage 1 to the oxidation line OL is sent to the oxidation gas heat exchanger 15 by the blower 11. The low-concentration methane gas LG preheated in the oxidation gas heat exchanger 15 is mixed, in the mixer 25, with the high-temperature exhaust gas EG from the gas turbine engine GT. At this time, the mixer 25 also serves as a preheater which further preheats the low-concentration methane gas LG with the exhaust gas EG. The mixed gas MG obtained in the mixer 25 is oxidized in the catalyst oxidizer 13, then heats the low-concentration methane gas LG at the oxidation gas heat exchanger 15, and is discharged to the outside of the system.

A first methane concentration sensor 45 is provided at the downstream side of the VAM supply source VS. In addition, in the low-concentration methane gas supply passage 1, an intake damper 47 which introduces outside air is provided at the downstream side of a branch point to the fuel supply passage 5 and at the upstream side of a branch point to the first oxidation line OL1. When the methane concentration of the low-concentration methane gas LG which is measured by the first methane concentration sensor 45 exceeds a predetermined value, the intake damper 47 is opened to introduce an air A, thereby lowering the methane concentration. The methane concentration after the air is introduced from the intake damper 47 is measured by a second methane concentration sensor 49 connected to the downstream side of the intake damper 47 (between the intake damper 47 and the oxidation line OL1).

Next, a method of operating the oxidation system ST configured as described above will be described. At the time of startup of the oxidation system ST, in the supply system for the gas turbine exhaust gas EG, the exhaust gas flow rate regulating valve 9 for the gas turbine exhaust gas EG and the heating medium on-off valves 21 of the second to fourth oxidation lines OL2 to OL4 are closed, and the heating medium on-off valve 21 of the first oxidation line OL1 is opened. In the supply system for the low-concentration methane gas LG, the low-concentration gas on-off valves 31 of the second to fourth oxidation lines OL2 to OL4 are closed, and the low-concentration gas on-off valve 31 of the first oxidation line OL1 is opened. At the time of startup, the aperture of the heating medium flow rate regulating valve 23 of the first oxidation line OL1 and the aperture of the low-concentration gas flow rate regulating valve 33 of the first oxidation line OL1 are respectively controlled by a controller 55, thereby setting the ratio of the flow rate of the low-concentration methane gas LG relative to the flow rate of the gas turbine exhaust gas EG as a heating medium to be small. In this state, the high-temperature gas turbine exhaust gas EG passes through the catalyst oxidizer 13 to heat the catalyst in the catalyst oxidizer 13, and thereafter, passes through the oxidation gas heat exchanger 15 to heat the low-concentration methane gas LG. The low-concentration methane gas LG is heated by the high-temperature gas turbine exhaust gas EG in the oxidation gas heat exchanger 15, is mixed with the high-temperature gas turbine exhaust gas EG in the mixer 25, and is catalytically oxidized in the catalyst oxidizer 13, and then is discharged to the outside together with the gas turbine exhaust gas EG.

After catalytic oxidation reaction is started in the catalyst oxidizer 13, as the catalyst combustion temperature increases, the flow rate of the gas turbine exhaust gas EG flowing into the first oxidation line OL1 is gradually decreased by reducing the aperture of the heating medium flow rate regulating valve 23 of the first oxidation line OL1, and simultaneously, the flow rate of the low-concentration methane gas LG flowing into the first oxidation line OL1 is gradually increased by increasing the aperture of the low-concentration gas flow rate regulating valve 33. After the catalytic oxidation reaction in the catalyst oxidizer 13 reaches a steady state, the heating medium flow rate regulating valve 23 and the heating medium on-off valve 21 of the first oxidation line OL1 are completely closed, and the system shifts to an independent oxidation state of the first oxidation line OL.

Meanwhile, the flow rate of the gas turbine exhaust gas EG flowing into the first oxidation line OL1 is gradually decreased by reducing the aperture of the heating medium flow rate regulating valve 23 of the first oxidation line OL1, and simultaneously, a flow rate of the gas turbine exhaust gas EG corresponding to the decrease in the inflow rate of the gas turbine exhaust gas EG into the first oxidation line OL1 is caused to flow into the second oxidation line OL2 by gradually opening the heating medium flow rate regulating valve 23 of the second oxidation line OL2. Simultaneously, the low-concentration gas flow rate regulating valve 33 of the second oxidation line OL2 is also opened to cause a small flow rate of the low-concentration methane gas LG to flow into the second oxidation line, and oxidation in the second oxidation line OL2 is started in the same procedure as that for the first oxidation line OL1.

Further, in the same procedure as described above, oxidation in the third oxidation line OL3 and oxidation in the fourth oxidation line OL4 are successively started. Finally, all the first to fourth oxidation lines OL1 to OL4 respectively enter their independent steady oxidation states, and the heating medium flow rate regulating valve 23 of the fourth oxidation line OL4 is closed. Thereafter, the exhaust gas flow rate regulating valve 9 for the gas turbine exhaust gas EG is opened to discharge the gas turbine exhaust gas EG from the exhaust gas flow rate regulating valve 9 to the outside.

The controller 55 controls the regulating valves, the on-off valves, the intake damper, and the like, based on the measurement values of the measurement instruments such as the temperature measurement units 41 and 42, the methane concentration sensors 45 and 47, and the like.

As described above, according to the low-concentration methane gas oxidation system ST of the present embodiment, since the plurality of catalyst oxidizers 13 can be started up by using the heat of the exhaust gas from the single heat source device, it is possible to treat an enormous amount of low-concentration methane gas at a low cost. Further, it is possible to suppress an increase in the installation space of the entire system while greatly enhancing the throughput of the system.

If the amount of heat of the gas turbine exhaust gas EG is insufficient to start up the oxidation device OD, as indicated by an alternate long and short dash line in FIG. 1 according to a modification of the first embodiment, an exhaust gas heating burner 61 which additionally heats the turbine exhaust gas EG at the time of startup may be provided at the upstream side of the branch point 19 to the first oxidation line OL1 in the heating medium supply passage 3.

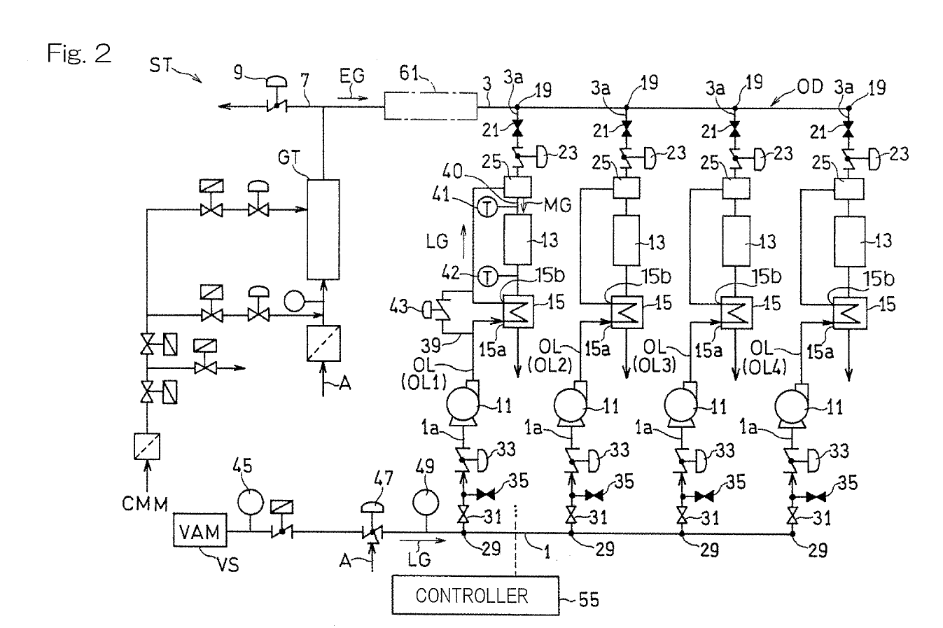

In another modification of the first embodiment, as the gas turbine engine GT which is a heat source device, instead of the lean fuel intake gas turbine which uses VAM as a working gas, an ordinary gas turbine engine as shown in FIG. 2 may be used which is not supplied with a fuel from the VAM supply source VS but is supplied with a fuel from the outside and uses air as a working gas. The heat source device is not limited to the gas turbine engine GT, and any device, such as a steam boiler, may be used as long as the device is capable of supplying a high-temperature gas without using VAM.

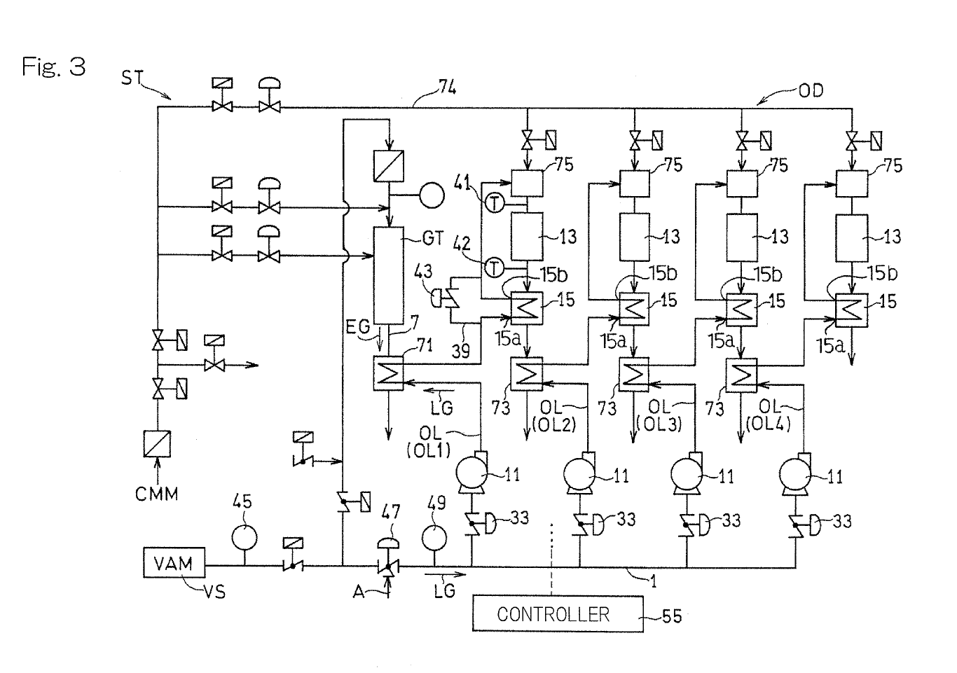

FIG. 3 shows an oxidation system ST according to a second embodiment of the present invention. In the first embodiment shown in FIG. 1, the heating medium (turbine exhaust gas EG) from the heat source device is directly introduced into the catalyst oxidizer 13 and used for preheating of the low-concentration methane gas LG and heating of the catalyst. However, in the second embodiment shown in FIG. 3, the gas turbine exhaust gas EG is not directly introduced into the catalyst oxidizer 13, but heats the low-concentration methane gas LG flowing through the first oxidation line OL1 via an exhaust gas heat exchanger (heat source gas heat exchanger) 71 which is a preheater provided at the downstream side of the gas turbine engine GT. In each of the second to fourth oxidation lines OL2 to OL4 which are additional oxidation lines, the exhaust gas exchanger 71 is not provided, and the low-concentration methane gas LG is preheated by using a gas oxidized in an oxidation line adjacent to and upstream of the oxidation line.

More specifically, the exhaust gas heat exchanger 71 is provided in the exhaust gas discharge passage 7 which discharges the turbine exhaust gas EG from the gas turbine engine GT, and the turbine exhaust gas EG as a heating medium passes through the exhaust gas heat exchanger 71. The low-concentration methane gas LG supplied to the first oxidation line OL1 by the blower 11 of the first oxidation line OL1 passes through the exhaust gas heat exchanger 71, and thereby is preheated by the turbine exhaust gas EG, and thereafter, is further preheated in the oxidation gas heat exchanger 15. The low-concentration methane gas LG having passed through the oxidation gas heat exchanger 15 is oxidized in the catalyst oxidizer 13, then passes through the oxidation gas heat exchanger 15 to preheat the low-concentration methane gas LG in the first oxidation line OL1, and thereafter, passes through the additional oxidation gas heat exchanger 73 to preheat the low-concentration methane gas LG in the second oxidation line OL2 adjacent to and downstream of the first oxidation line OL1, and finally, is discharged to the outside of the system. Also in the second to fourth oxidation lines OL2 to OL4, oxidation is successively performed in the same manner as described above.

In the present embodiment, a preheating burner 75 which operates using, as a fuel, CMM supplied from a CMM supply passage 74 is provided at the upstream side of the catalyst oxidizer 13. When the gas turbine engine GT is stopped for maintenance or the like, the low-concentration methane gas LG is preheated by the preheating burner 75 when the oxidation device OD is started up.

In the present embodiment, the low-concentration methane gas LG flowing into the catalyst oxidizer 13 of the first oxidation line OL1 is preheated in two stages by the exhaust gas heat exchanger 71 and the oxidation gas heat exchanger 15 (in the second to fourth oxidation lines OL2 to OL4, the additional oxidation gas heat exchanger 73 and the oxidation gas heat exchanger 15), and thus self-sustaining operation is realized even for a lower-concentration methane gas.

Although the present invention has been described above in connection with the embodiments thereof with reference to the accompanying drawings, numerous additions, changes, or deletions can be made without departing from the gist of the present invention. Accordingly, such additions, changes, or deletions are to be construed as included in the scope of the present invention.

### REFERENCE NUMERALS

1 Low-concentration gas supply passage
1a Branching low-concentration gas supply passage
13 Catalyst oxidizer
15 Oxidation gas heat exchanger
EG Turbine exhaust gas (heat source gas)
GT Gas turbine (heat source device)
LG Low-concentration methane gas
OD Low-concentration methane gas oxidation device
OL Oxidation line
ST Low-concentration methane gas oxidation system

What is claimed is:

1. A low-concentration methane gas oxidation system, comprising:
a single heat source device; and
an oxidation device to catalytically oxidize a low-concentration methane gas by using heat from the single heat source device,
the oxidation device including a plurality of oxidation lines, and each oxidation line including: each of a plurality of branching low-concentration gas supply passages which branch, in parallel, from a supply passage to supply the low-concentration methane gas; and each of catalyst oxidizers provided on each of the plurality of branching low-concentration gas supply passages.

2. The low-concentration methane gas oxidation system as claimed in claim 1, wherein the oxidation lines include
a first oxidation line including: a first catalyst oxidizer provided on a first branching low-concentration gas supply passage branching from the most upstream side of the supply passage; a first preheater to preheat the low-concentration methane gas before the low-concentration methane gas flows into the first catalyst oxidizer, by using the heat from the heat source device; and a first heat exchanger to preheat the low-concentration methane gas before the low-concentration methane gas flows into the first catalyst oxidizer, by using, as a heating medium, a treated gas discharged from the first catalyst oxidizer, and
at least one additional oxidation line branching from the downstream side of the first oxidation line in the supply passage, and including: an additional catalyst oxidizer to catalytically oxidize the low-concentration methane gas; an additional preheater to preheat the low-concentration methane gas before the low-concentration methane gas flows into the additional catalyst oxidizer, by using the heat from the heat source device or heat of a gas oxidized in another oxidation line provided at an upstream side thereof; and an additional heat exchanger to preheat the low-concentration methane gas before the low-concentration methane gas flows into the additional catalyst oxidizer, by using, as a heating medium, a gas oxidized in the additional oxidation line.

3. The low-concentration methane gas oxidation system as claimed in claim 2, wherein the first oxidation line includes, as the first preheater, a mixer to mix the low-concentration methane gas with a heat source gas supplied from the heat source device, and
the at least one additional oxidation line includes, as the additional preheater, a mixer to mix the low-concentration methane gas with a high-temperature gas supplied from the heat source device.

4. The low-concentration methane gas oxidation system as claimed in claim 3, wherein each of the first oxidation line and the at least one additional oxidation line is provided with a low-concentration gas flow rate regulating valve to regulate an inflow rate of the low-concentration methane gas, and a heating medium flow rate regulating valve to regulate an inflow rate of the heat source gas.

5. The low-concentration methane gas oxidation system as claimed in claim 2, wherein the first oxidation line includes, as the first preheater, a heat source gas heat exchanger to preheat the low-concentration methane gas by using, as a heating medium, the heat source gas supplied from the heat source device, and
the at least one additional oxidation line includes, as the additional preheater, an additional oxidation gas heat exchanger which uses, as a heating medium, the gas oxidized in the another oxidation line at the upstream side thereof.

6. The low-concentration methane gas oxidation system as claimed in claim 1, wherein the heat source device is a lean fuel intake gas turbine which operates using, as a fuel, a combustible component contained in the low-concentration methane gas.

7. A method of operating the low-concentration methane gas oxidation system as claimed in claim 4, comprising:
when the system is started up, closing the low-concentration gas flow rate regulating valve and the heating medium flow rate regulating valve of the additional oxidation line, and controlling an aperture of the low-concentration gas flow rate regulating valve and an aperture of the heating medium flow rate regulating valve of the first oxidation line such that the inflow rate of the low-concentration methane gas is smaller than the inflow rate of the heat source gas;
in the first oxidation line, after oxidation in the first catalyst oxidizer is started, reducing the aperture of the heating medium flow rate regulating valve and increasing the aperture of the low-concentration gas flow rate regulating valve in accordance with an increase in a catalyst combustion temperature in the first catalyst oxidizer;
after catalytic oxidation reaction reaches a steady state in the first catalyst oxidizer in the first oxidation line, closing the heating medium flow rate regulating valve and the low-concentration gas flow rate regulating valve of the first oxidation line;
in the additional oxidation line provided at the downstream side of the first oxidation line, increasing the aperture of the heating medium flow rate regulating valve of the additional oxidation line in association with a reduction in the aperture of the heating medium flow rate regulating valve of the first oxidation line, thereby to cause a flow rate of the heat source gas corresponding to a decrease in the inflow rate of the heat source gas into the first oxidation line to flow into the additional oxidation line, and opening the low-concentration gas flow rate regulating valve of the additional oxidation line, thereby to cause a smaller inflow rate of the low-concentration methane gas than the inflow rate of the heat source gas to flow into the additional oxidation line; and
in a case where a plurality of the additional oxidation lines are provided, successively repeating, between an upstream-side additional oxidation line and a downstream-side additional oxidation line, the above-described procedures in the first oxidation line and the additional oxidation line at the downstream side of the first oxidation line.
